(19) United States
(12) Patent Application Publication
(10) Pub. No.: US 2026/0097932 A1
(43) Pub. Date: Apr. 9, 2026

(54) SENSOR APPARATUS AND SYSTEM FOR DETECTING A TRAVEL REGION OF AN INDUSTRIAL ROBOT

(71) Applicant: SICK AG, Waldkirch (DE)

(72) Inventors: Tiberius PISCHKE, Freiburg (DE); Ralf KLEIN, Heitersheim (DE); Albrecht BERGEMANN, Hamburg (DE)

(21) Appl. No.: 19/352,441

(22) Filed: Oct. 7, 2025

(30) Foreign Application Priority Data
Oct. 8, 2024 (EP) 24205378.3

(51) Int. Cl. B66C 13/46; B66C 17/06

(52) U.S. Cl. CPC B66C 13/46; B66C 17/06

(57) ABSTRACT

The invention relates to a sensor apparatus for detecting the travel region of an industrial robot, in particular a crane for moving containers, wherein the sensor apparatus comprises at least one first environmental sensor and one second environmental sensor, wherein the first environmental sensor emits transmission light in a plurality of first layers for an environmental detection, and wherein the second environmental sensor emits transmission light in a plurality of second layers for an environmental detection, wherein the environmental sensors are arranged such that the first layers of the transmission light of the first environmental sensor coincide with the second layers of the transmission light of the second environmental sensor in an overlap region of the fields of view of the environmental sensors, or such that the first layers of the transmission light of the first environmental sensor alternate with the second layers of the transmission light of the second environmental sensor in the overlap region of the fields of view of the environmental sensors.

The invention relates to a sensor apparatus, to a system and to a use of the system for detecting the travel region of an industrial robot, in particular a crane for moving containers.

The safeguarding of the travel region of an industrial robot may be required to prevent damage to property and/or personal injury. An industrial robot can also be understood as an industrial vehicle. The industrial robot can be manually controlled, can move in a partly automated manner and/or can move in a fully automated manner. An industrial robot can refer to a crane, in particular a rail-mounted (gantry) crane for moving containers. An industrial robot can also refer to a construction machine or a construction vehicle, an agricultural machine or an agricultural vehicle, a forestry machine or a forestry vehicle, a mining machine or a mining vehicle, an earth-moving machine or an earth-moving vehicle, or a cleaning machine or a cleaning vehicle.

A safeguarding of the travel region of such an industrial robot is often protected by means of guards, for example fences. However, such an approach can be associated with high investment costs, service costs and maintenance costs. This can in particular apply to rail-guided (gantry) cranes whose travel region can typically extend on rails with a length of up to 2 km.

A spatial (three-dimensional) safe environment detection by means of sensors in the sense of ESPE (electro-sensitive protective equipment) has the potential to be able to make guards (e.g. fences) obsolete. However, this requires a sensor technology that ensures both the systematic properties and the detection capability for the safe recognition of a person or an object in the travel region of an industrial robot under as many different environmental conditions as possible and/or establishes a safe state of the industrial robot. In this respect, the terms safe or safety used herein can be understood within the meaning of certain safety-specific standards, such as ISO 13849 or IEC 62998. For safety-oriented applications, errors should or must be controllable up to a certain safety level and, for example, with a so-called “Performance Level” (PL) in accordance with ISO 13849. Certification standards of a certain “Performance Class” (PC) according to IEC 62998 should also be able to be fulfilled by the sensor technology. Further relevant and partly safety-specific standards are ISO 12100, ISO 18497, ISO 25119, ISO 17757, ISO 21815, ISO 19014, ISO 13482, IEC 63327, IEC 60721, ISO 3691-4.

The invention is based on the object of providing a safe and efficient safeguarding of the travel region of an industrial robot.

A sensor apparatus having the features of claim 1 is provided to satisfy the object.

The sensor apparatus according to the invention for detecting the travel region of an industrial robot, in particular a (rail-mounted) crane for moving containers, comprises at least one first environmental sensor and one second environmental sensor, wherein the first environmental sensor emits transmission light in a plurality of first layers for an environmental detection, and wherein the second environmental sensor emits transmission light in a plurality of second layers for an environmental detection, wherein the environmental sensors are arranged such that the first layers of the transmission light of the first environmental sensor coincide with the second layers of the transmission light of the second environmental sensor in an overlap region of the fields of view of the environmental sensors, or such that the first layers of the transmission light of the first environmental sensor alternate with the second layers of the transmission light of the second environmental sensor in the overlap region of the fields of view of the environmental sensors.

The sensor apparatus according to the invention is preferably mountable at the industrial robot, and is in particular mountable at a crane leg of a crane.

An environmental sensor can refer to a laser scanner, and in particular a multi-beam laser scanner, or a LiDAR (Light Detection And Ranging) sensor. The environmental sensors can emit transmission light in a plurality of layers (by means of a light transmitter) in order to detect and in particular to scan an environment. It is understood that the environmental sensors can receive transmission light diffusely reflected or generally remitted at objects in the environment as reception light (by means of a light receiver) and can preferably measure the distances of the objects (relative to the respective environmental sensor) based on the reception light, for example, using a time-of-flight method. In this respect, a so-called warning or protective field can be configured in the environmental sensors; in the event of a violation of said warning or protective field, a warning signal can, for example, be output and/or a machine stop of the industrial robot can be initiated.

In other words, the invention is based on the realization that the safety of the detection of the travel region of the industrial robot can be increased if the environmental sensors are arranged in one of the two different ways. As a result, a safe and efficient safeguarding of the travel region of the industrial robot can ultimately be achieved. The two different possibilities of arranging the sensors can each offer certain advantages for different application situations.

On the one hand, the sensors can be arranged such that the first layers of the transmission light of the first environmental sensor coincide with the second layers of the transmission light of the second environmental sensor in the overlap region of the fields of view of the environmental sensors and in this respect preferably detect at least one part of the travel region redundantly. This can mean that, in the overlap region of the fields of view, at least one of the first layers completely overlaps and/or is congruent with one of the second layers, wherein each of the first layers is preferably congruent with a respective one of the second layers in the overlap region of the fields of view. As a result, more pixels per unit length or per area are recorded in the overlapping layers, preferably twice as many. This redundant detection or scanning can ensure a safe detection (and monitoring) of the travel region of the industrial robot. If, for example, one environmental sensor fails, the detection of an object or a person in the travel region can still take place by the other environmental sensor. In other words, due to the redundancy, the probability of failure can be reduced and the safety of the detection can be increased.

On the other hand, the environmental sensors can be arranged such that the first layers of the transmission light of the first environmental sensor alternate with the second layers of the transmission light of the second environmental sensor in the overlap region of the fields of view of the environmental sensors. This can mean that, in the overlap region of the fields of view, at least one layer of the first layers is arranged between two layers of the second layers that are disposed directly next to one another (with the exception of the one layer of the first layers). In other words, the first and the second layers can be arranged in a mutually alternating or fanned-out manner in the overlap region of the fields of view. Preferably, each of the first layers is arranged in the overlap region of the fields of view in each case between two layers of the second layers that are disposed directly next to one another (with the exception of the respective layer of the first layers).

It is understood that the sensor apparatus can also have more than two environmental sensors, for example three, four, five or six environmental sensors. The further environmental sensors can likewise emit transmission light in a plurality of layers, wherein the layers of transmission light of all or a plurality of environmental sensors can alternate and/or overlap in the overlap region. For example, an alternation can be designed such that, between two layers of transmission light of one environmental sensor that are arranged directly next to one another, at least one layer of transmission light of another environmental sensor is arranged. It is also possible for the layers of some of the environmental sensors to be arranged in an alternating manner, wherein the layers of some others of the environmental sensors coincide at least partly with the alternating layers. Thus, the advantages of the alternating and coinciding layers can also be simultaneously achieved.

In the alternating or fanned-out arrangement, the effective resolution and/or number of pixels of the (combined) environmental sensors can be increased. Typical environmental sensors can, for example, be configured to emit transmission light in 16 layers. However, viewed at a distance of several meters (e.g. more than 20 m) from the environmental sensors, intermediate spaces can arise between the layers, wherein the intermediate spaces can reach an extent of more than 2 m. A person or an object that is located in or moves into precisely such a (non-detected) intermediate space can therefore literally “disappear” in this intermediate space and can possibly be overlooked. Due to the alternating arrangement, these intermediate spaces between the layers of one environmental sensor can be detected by the layers of the other environmental sensor. In other words, in the overlap region of the fields of view of the environmental sensors, at least one part of the travel region can preferably be detected at a higher density, i.e. a higher percentage of the overlap region is scanned. Therefore, a “merged” resolution can thereby result, wherein the merged resolution (i.e. the number of recorded pixels) is higher than the resolution of the environmental sensors taken alone in each case. In this way, a certain PL, for example PL r, can be achieved, even if both or one of the environmental sensors, taken alone in each case, is possibly not configured as a safety sensor according to PL r. Furthermore, due to the offset positioning of the environmental sensors and, as a result, the scanning of the environment from two (slightly) different directions, image interference or interfering reflections, which can, for example, occur on very strongly (in particular diffusely) reflecting objects (e.g. reflective surfaces or reflectors) in the field of view of the environmental sensors, can be better compensated. In this way, the safety of the detection (and monitoring) of the travel region of the industrial robot can be increased overall.

The sensor apparatus can be suitable for safety-related applications and can preferably achieve a PL r (according to ISO 13849).

It is understood that the overlap region can refer to a three-dimensional volume in which the (three-dimensional) fields of view of the environmental sensors overlap. Furthermore, it is understood that the environmental sensors can substantially face in the same direction so that their fields of view at least partly overlap.

According to one embodiment, the first environmental sensor and the second environmental sensor each comprise a laser scanner, in particular a multi-beam laser scanner. The layers of the transmission light can accordingly refer to the scanning layers with which the laser scanner scans the environment.

According to one embodiment, the sensor apparatus further comprises a holder for the environmental sensors, wherein the holder is configured to hold (in a static or variable manner) the environmental sensors at least in a first sensor arrangement or in a second sensor arrangement different from the first sensor arrangement, wherein, in the first sensor arrangement, the first layers of the transmission light of the first environmental sensor coincide with the second layers of the transmission light of the second environmental sensor in the overlap region of the fields of view of the environmental sensors and, in the second sensor arrangement, the first layers of the transmission light of the first environmental sensor alternate with the second layers of the transmission light of the second environmental sensor in the overlap region of the fields of view of the environmental sensors.

The holder can comprise a mounting plate, a fine adjustment holder, an encoder, a fastening means, screw locking devices and/or a pole mount.

The holder can be mountable at the industrial robot.

According to one embodiment, the holder comprises at least one marking, wherein the marking is arranged at the holder such that the marking can be detected by the first environmental sensor and/or by the second environmental sensor for diagnostic purposes.

Additionally or alternatively, the sensor apparatus can comprise a marking that can be applied to the industrial robot, in particular at a predetermined position to the industrial robot, wherein the marking can be arranged at the industrial robot such that the marking can be detected by the first environmental sensor and/or by the second environmental sensor for diagnostic purposes.

The marking can refer to a visual marking, wherein the marking can comprise, for example, a colored surface and/or a pattern.

The marking can be detected by the first environmental sensor and/or by the second environmental sensor, and preferably by both environmental sensors, for diagnostic purposes. In other words, the environmental sensors can, for example always before the industrial robot approaches, acquire sensor data about the marking on request and/or at regular intervals and can carry out a diagnosis or a data plausibility check based on the acquired sensor data about the marking. Since the marking is applied directly to the holder itself, the calibration or the training of the recognition of the marking in the sensor data can already be carried out (ex works) before the sensor apparatus is mounted at the industrial robot. Furthermore, if it, for example, becomes apparent from the diagnosis that the orientation of the environmental sensors is not yet optimal for a certain PL (performance level), the holder can be readjusted (ex works and/or before assembly at the industrial robot) more easily and/or more cost-effectively. The PL of the sensor apparatus can also be increased overall and/or a certain PL of the sensor apparatus can be achieved.

According to one embodiment, the sensor apparatus comprises a processing apparatus that is configured, based on reception light received by the first environmental sensor and/or by the second environmental sensor, to obtain sensor data about the environment, in particular about at least one part of the travel region of the industrial robot, in particular to measure said sensor data using a time-of-flight method.

According to one embodiment, the processing apparatus is configured to determine a hazardous state based on the sensor data, i.e. to determine that a person and/or an object is located in the travel region, and, in response to the determination of the hazardous state, to output a (warning) signal and/or to set the industrial robot into a safeguarded control mode.

For this purpose, the sensor apparatus can be in a wired or wireless signal connection with the industrial robot. The safeguarded control mode can comprise a machine stop, a slowing down of the movement and/or a direction change or route change of the movement of the industrial robot.

According to one embodiment, the processing apparatus is configured to obtain first sensor data based on the reception light received by the first environmental sensor and to obtain second sensor data based on the reception light received by the second environmental sensor, to determine a first position of the marking or a second position of the marking based on the first sensor data and the second sensor data by means of time-of-flight methods and/or an optical distortion of the marking and/or to determine a third position of the marking based on both sensor data by means of lateration and/or triangulation, and to determine an error state of the environmental sensors in that a deviation can be determined on a comparison of the determined first, second and/or third position of the marking with one another and/or on a comparison of the determined first, second and/or third position of the marking with a predetermined position of the marking, and/or in that a change in the first, second and/or third position of the marking can be determined over time.

It is understood that in this case the marking at the holder can preferably be detected by both environmental sensors. A position of the marking can refer to a position of the marking relative to the first and/or second environmental sensor.

The processing apparatus can, for example, comprise a computing unit (i.e. a processor) and a storage medium. The processing apparatus can be a separate processing apparatus that is in a wireless or wired signal connection with the environmental sensors. The sensor apparatus can also be provided by the environmental sensors themselves. For example, the functions of the sensor apparatus that are described herein can also be provided, partly or completely, by the environmental sensors themselves. A position of the marking, in particular the first and/or second position, can optionally be calculated by the processing apparatus based on the respective sensor data or can also already be calculated by the respective environmental sensor itself so that only the calculated position is transmitted to the processing apparatus.

The marking can, for example, comprise a specific pattern, wherein the position of the marking relative to the first and/or second environmental sensor can then be determined by means of an optical distortion of the pattern. Alternatively or additionally, the first and second position of the marking can each be measured by means of time-of-flight methods.

A third position of the marking can be determined by lateration and/or triangulation based on both sensor data. For example, based on the first sensor data, a first distance of the position of the marking relative to the first environmental sensor and a second distance of the position of the marking relative to the second environmental sensor can be determined. The third position of the marking can then correspond to the point, region or volume at which a first region (or volume) defined by the first distance as the radius and a second region (or volume) defined by the second distance as the radius overlap. Alternatively or additionally, based on the first sensor data, a first direction of the position of the marking can be determined, starting from the first environmental sensor, and a second direction of the position of the marking can be determined, starting from the second environmental sensor. The third position of the marking can then correspond to the point, region or volume at which the first and the second direction intersect. A direction can refer to an angular range that is determined by an azimuth angle and/or elevation angle.

It is understood that the determined first and/or second position of the marking, and vice versa, can also be used for the determination of the third position of the marking. In this way, the accuracy of the position determination of the marking and the robustness of the diagnosis can be improved.

The position and/or orientation of the environmental sensors relative to one another can be known, e.g. by a calibration ex works. Furthermore, a position of the marking relative to the first and/or second environmental sensor can be predetermined or known, for example, by a calibration ex works. Alternatively or additionally, the marking can, for example, be applied or able to be applied to the industrial robot at a known position, wherein a calibration can then take place prior to the initial commissioning and can be carried out on site, i.e. at the location of the intended use. In this way, the determined first, second and/or third position of the marking can be compared with one another by conversion and/or the determined first, second and/or third position of the marking can be compared with the predetermined position in order to determine the error state. It is understood that the processing apparatus can be configured to output a (warning) signal in response to the determination of the error state. The signal can indicate, for example, that a maintenance of the sensor apparatus is required. In this way, the safety of the detection of the travel region can be increased overall or the safeguarding of the travel region can be increased.

According to one embodiment, the holder is configured to variably hold the environmental sensors at least between the first sensor arrangement and the second sensor arrangement. In this way, it is possible to flexibly switch between the first and the second sensor arrangement in order, for example, to be able to flexibly react to changes in the environment and/or to be able to utilize the advantages of the respective sensor arrangement depending on the situation and requirements.

According to one embodiment, the environmental sensors are arranged next to one another or above one another.

According to one embodiment, the environmental sensors are arranged at a specific distance from one another. Preferably, the distance is between 0 m and 2 m, preferably 0 m to 1 m, preferably 0 m to 0.5 m, and even further preferably 0.25 m to 0.5 m. Preferably, the environmental sensors are arranged directly adjoining one another. Alternatively, the environmental sensors can be arranged at a distance of up to 30 cm from one another. The holder, in particular the size of the holder, is therefore configured to hold the environmental sensors at the specific distance. For example, a width and/or a height of the holder can be equal to or less than 2 m, preferably equal to or less than 1 m and even more preferably equal to or less than 0.5 m.

According to one embodiment, one of the environmental sensors is arranged tilted and/or rotated, in particular rotated by 180°, with respect to the other so that the first layers of the transmission light of the first environmental sensor alternate with the second layers of the transmission light of the second environmental sensor in the overlap region of the fields of view of the environmental sensors. It is understood that the axis of rotation for the rotation can be substantially parallel to the direction of travel of the industrial robot, can be substantially parallel to the orientation of the other (non-rotated) environmental sensor, and/or can substantially correspond to the orientation of the rotated environmental sensor itself. In other words, one of the environmental sensors can be, or can be positioned, “upside down” compared to the other. The axis of the tilt can be substantially orthogonal to the direction of travel of the industrial robot, substantially orthogonal to the orientation of the other (non-tilted) environmental sensor, and/or substantially orthogonal to the orientation of the tilted environmental sensor itself. The axis of the tilt can also be substantially parallel to the floor (on which the industrial robot moves) or substantially horizontal to the floor so that the tilted environmental sensor is inclined upwardly towards the floor or away from the floor.

Such a second sensor arrangement can in particular be useful if the layers in which the environmental sensors emit transmission light are not uniformly distributed and/or have the same angular extent. For example, the layers of the transmission light inside the field of view of an environmental sensor can be closer together than in outer regions of the field of view of the environmental sensor. These irregularities can be (at least partly) compensated by the rotation and/or tilting.

Furthermore, it can be achieved by the tilting that the environmental sensors cover a larger vertical field of view overall. An increased PL can be achieved in the overlap region of the fields of view by the alternating arrangement of the layers. The remaining regions of the fields of view of the environmental sensors can be detected by a respective one of the two environmental sensors, wherein these remaining regions can, however, extend further upwardly and/or downwardly (compared to the fields of view of the environmental sensors in a non-tilted arrangement). In this way, for example, parts of the travel region that are disposed further up and/or further down and/or regions above and/or below the travel region can also be detected. For example, an overhanging container disposed above the travel region of a crane can be detected and a machine stop of the crane can be triggered in response to the detection of the container.

According to one embodiment, the first and/or the second environmental sensor is/are configured as a safety sensor. Both environmental sensors are preferably configured as safety sensors. In this way, a certain PL can be achieved and/or the PL of the sensor apparatus can be increased.

According to one embodiment, the first and/or the second environmental sensor comprises/comprise a respective field of view of equal to or more than 180°, preferably equal to or more than 225°, preferably equal to or more than 270°, preferably equal to or more than 315°, and preferably equal to 360°. In this way, larger side regions of the travel region and/or regions outside the travel region can be detected (in each case by one of the two environmental sensors). It is understood that the holder can be configured in this case such that the fields of view of the environmental sensors are obstructed as little as possible. The environmental sensors can, for example, each be arranged at a margin of the holder. The marking on the holder can also be arranged between the environmental sensors.

A further subject of the invention is a use of a sensor apparatus described herein for detecting the travel region of an industrial robot, in particular a crane for moving containers.

A further subject of the invention is a system for detecting the travel region of an industrial robot, in particular a crane for moving containers, said system comprising the industrial robot, and at least one sensor apparatus described herein, wherein the sensor apparatus is mounted at the industrial robot.

According to one embodiment, the system comprises at least one marking, wherein the marking is arranged at the holder and/or at the industrial robot such that the marking can be detected by the first environmental sensor and/or by the second environmental sensor for diagnostic purposes.

According to one embodiment, the industrial robot is a crane, in particular a rail-mounted (gantry) crane.

According to one embodiment, the crane comprises at least one first crane leg disposed in the direction of travel of the crane and at least one second crane leg disposed opposite to the direction of travel of the crane, wherein at least one sensor apparatus is mounted at the first and at the second crane leg in each case, and is in particular mounted at a trailer bogie of a respective crane leg, wherein preferably the sensor apparatus at the first crane leg is oriented in the direction of travel of the crane and the sensor apparatus at the second crane leg is oriented opposite to the direction of travel of the crane.

According to one embodiment, the sensor apparatuses have the same sensor arrangement or a different sensor arrangement. For example, both sensor apparatuses can either have a first sensor arrangement described herein of the environmental sensors or a second sensor arrangement described herein of the environmental sensors. Alternatively, one sensor apparatus can have the first sensor arrangement of the environmental sensors and the other sensor apparatus can have the second sensor arrangement of the environmental sensors.

According to one embodiment, the sensor apparatuses are configured such that, and in particular the environmental sensors of both sensor apparatuses are configured and held such that, the environmental sensors also (redundantly or alternately) detect a region between the crane legs.

According to one embodiment, the sensor apparatuses are mounted at the same height at the industrial robot, i.e. the crane.

According to one embodiment, the crane comprises two first crane legs disposed in the direction of travel of the crane and two second crane legs disposed opposite to the direction of travel of the crane, wherein at least one sensor apparatus is mounted at each of the crane legs, and is in particular mounted at a trailer bogie of a respective crane leg, and wherein preferably the sensor apparatuses at the first crane legs are oriented in the direction of travel of the crane and the sensor apparatuses at the second crane legs are oriented opposite to the direction of travel of the crane.

According to one embodiment, the crane comprises two first crane legs disposed in the direction of travel of the crane and two second crane legs disposed opposite to the direction of travel of the crane, wherein at least one sensor apparatus oriented in the direction of travel of the crane and at least one sensor apparatus oriented opposite to the direction of travel of the crane are mounted at each of the crane legs.

According to one embodiment, the industrial robot, i.e. the crane, can change the direction of travel and can in particular travel alternately in one direction or in the opposite direction. It is understood that a sensor apparatus that is mounted at the industrial robot and that is first oriented in the direction of travel is then oriented opposite to the direction of travel after a change of direction, and vice versa.

It is understood that what is described with respect to the sensor apparatus according to the invention also applies to the use of the sensor apparatus and the system. This in particular applies to embodiments and advantages. Furthermore, it is to be understood that all the features and embodiments disclosed herein can be combined unless explicitly stated otherwise.

The invention will be described in the following purely by way of example with reference to possible embodiments and to the enclosed drawing. There are shown:

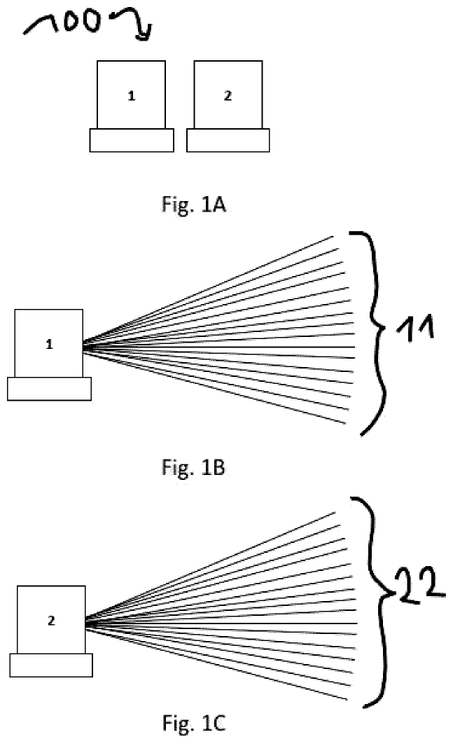

FIG. 1A a schematic representation of the front view of a sensor apparatus in a first sensor arrangement;

FIG. 1B a schematic representation of a side view of a first environmental sensor in the first sensor arrangement;

FIG. 1C a schematic representation of a side view of a second environmental sensor in the first sensor arrangement;

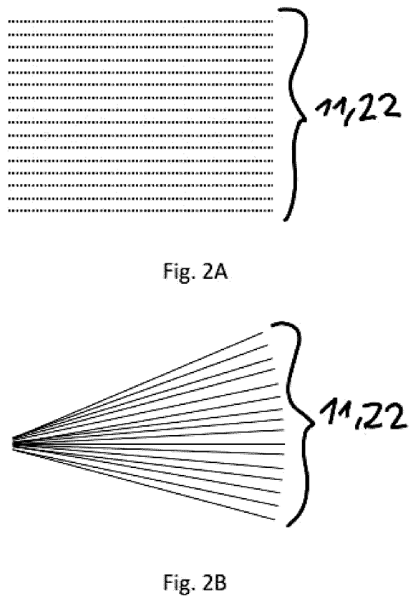

FIG. 2A a schematic representation of the front view of an overlap region of the fields of view of the environmental sensors in the first sensor arrangement;

FIG. 2B a schematic representation of a side view of an overlap region of the fields of view of the environmental sensors in the first sensor arrangement;

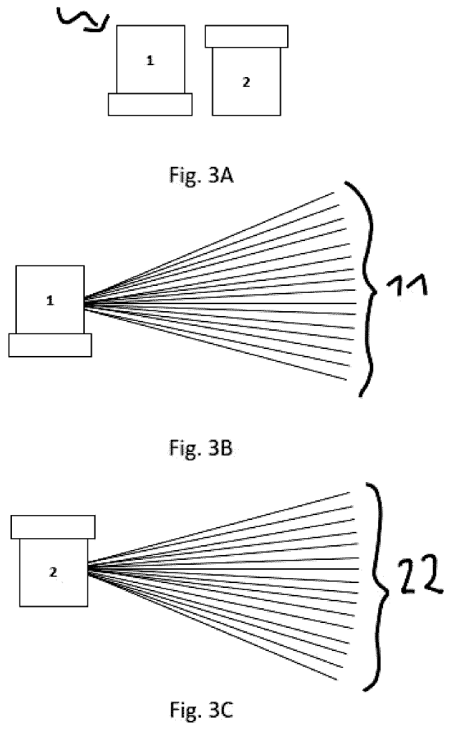

FIG. 3A a schematic representation of the front view of a sensor apparatus in a second sensor arrangement;

FIG. 3B a schematic representation of a side view of a first environmental sensor in the second sensor arrangement;

FIG. 3C a schematic representation of a side view of a second environmental sensor in the second sensor arrangement;

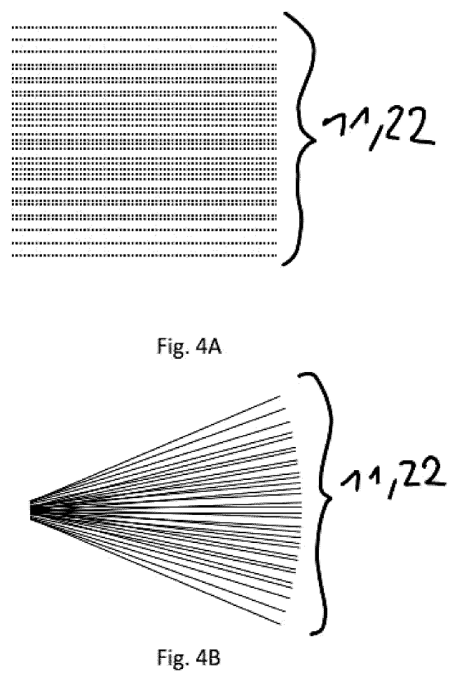

FIG. 4A a schematic representation of the front view of an overlap region of the fields of view of the environmental sensors in the second sensor arrangement;

FIG. 4B a schematic representation of a side view of an overlap region of the fields of view of the environmental sensors in the second sensor arrangement;

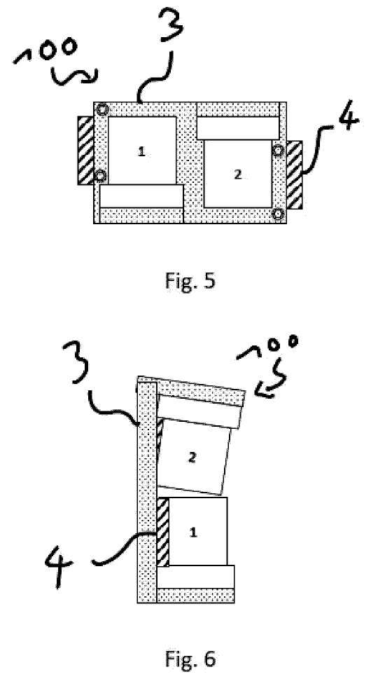

FIG. 5 a schematic representation of the front view of a sensor apparatus in a second sensor arrangement;

FIG. 6 a schematic representation of a side view of a sensor apparatus in a second sensor arrangement;

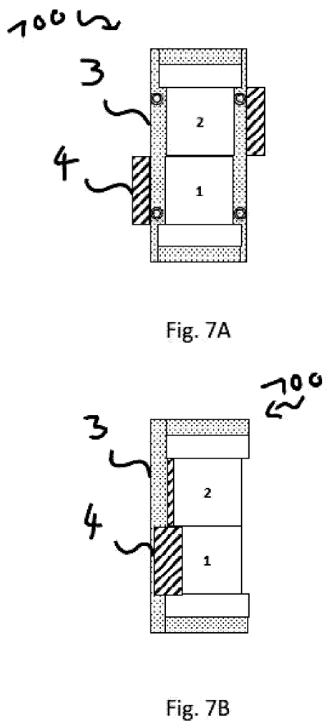

FIG. 7A a schematic representation of the front view of a sensor apparatus in a second sensor arrangement;

FIG. 7B a schematic representation of a side view of the sensor apparatus in the second sensor arrangement;

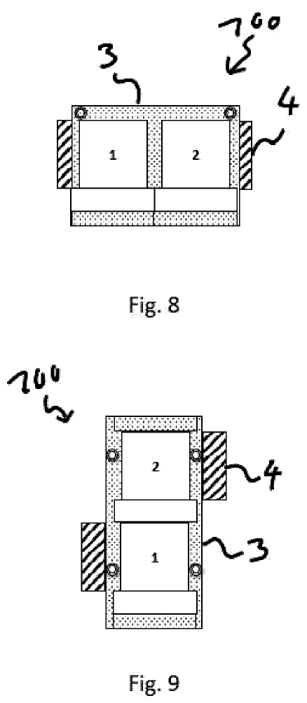

FIG. 8 a schematic representation of the front view of a sensor apparatus in a first sensor arrangement;

FIG. 9 a schematic representation of the front view of a sensor apparatus in a first sensor arrangement;

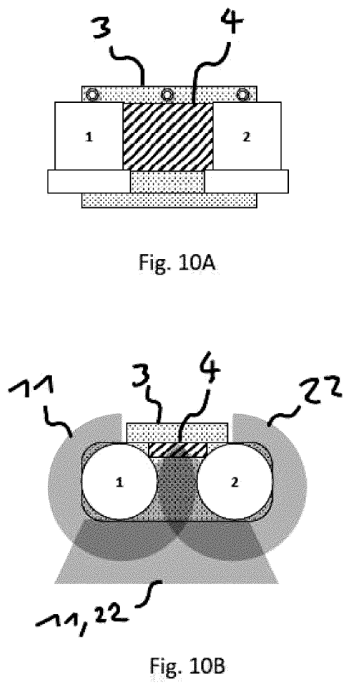

FIG. 10A a schematic representation of the front view of a sensor apparatus in a first sensor arrangement;

FIG. 10B a schematic representation of the plan view of the sensor apparatus in the first sensor arrangement;

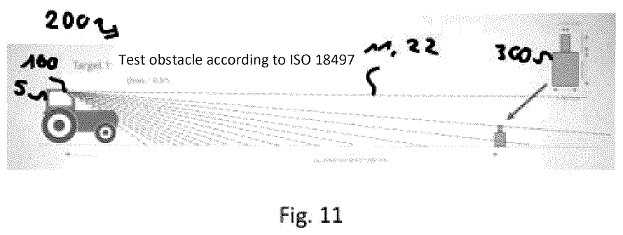

FIG. 11 a schematic representation of a side view of a system; and

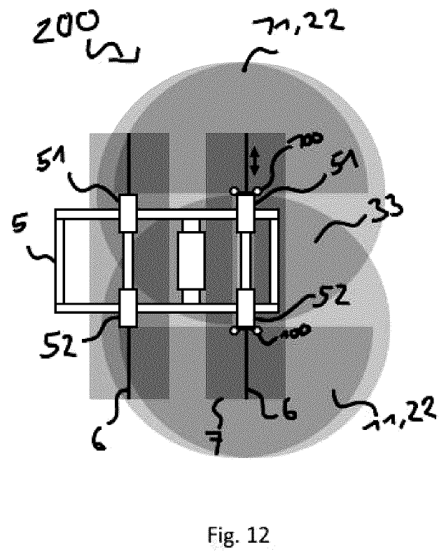

FIG. 12 a schematic representation of a plan view of a system.

FIG. 1A shows a schematic representation of the front view of a sensor apparatus 100 in a first sensor arrangement. The sensor apparatus 100 for detecting a travel region of an industrial robot (not shown in FIG. 1A) comprises at least one first environmental sensor 1 and one second environmental sensor 2. The sensor apparatus 100 further comprises a holder (not shown in FIG. 1A) for the environmental sensors 1, 2, wherein the holder is configured to hold the environmental sensors 1, 2 in the first sensor arrangement. In the first sensor arrangement shown in FIG. 1A, the environmental sensors are arranged next to one another.

FIG. 1B and FIG. 1C show a schematic representation of a side view of the first environmental sensor 1 or the second environmental sensor 2 in a first sensor arrangement, such as is shown in FIG. 1A. The first environmental sensor 1 emits transmission light in a plurality of first layers 11 for an environmental detection. The second environmental sensor 2 emits transmission light in a plurality of second layers 22 for an environmental detection.

FIG. 2A and FIG. 2B show a schematic representation of the front view or of a side view of an overlap region of the fields of view of the environmental sensors in a first sensor arrangement, such as is shown in FIG. 1A. In the first sensor arrangement, the environmental sensors 1, 2 are arranged in such a manner (and for example next to one another as in FIG. 1A) that the first layers 11 of the transmission light of the first environmental sensor 1 coincide with the second layers 22 of the transmission light of the second environmental sensor 2 in an overlap region of the fields of view of the environmental sensors 1, 2. In other words, the environmental sensors 1, 2 can detect at least one part of the travel region redundantly. Preferably, as shown in FIGS. 2A and 2B, in the overlap region of the fields of view, each of the first layers 11 is congruent with a respective one of the second layers 22 so that, in the overlap region of the fields of view of the environmental sensors 1, 2, the total number of (scanning) layers with which the environment is effectively detected corresponds to the number of first layers 11 of the transmission light of the first environmental sensor 1 or to the number of second layers 22 of the transmission light of the second environmental sensor.

FIG. 3A shows a schematic representation of the front view of a sensor apparatus 100 in a second sensor arrangement. The sensor apparatus 100 shown in FIG. 3A comprises similar components to the sensor apparatus shown in FIG. 1A, wherein the holder (not shown in FIG. 3A) for the environmental sensors 1, 2 is, however, configured to hold the environmental sensors 1, 2 in a second sensor arrangement different from the first sensor arrangement. In the second sensor arrangement shown in FIG. 3A, the environmental sensors are arranged next to one another, wherein the second environmental sensor 2 is, however, rotated by 180° so that it is “upside down” compared to the first environmental sensor 1.

FIG. 3B and FIG. 3C show a schematic representation of a side view of the first environmental sensor 1 and the second environmental sensor 2, respectively, in a second sensor arrangement, such as is shown in FIG. 3A. The first environmental sensor 1 emits transmission light in a plurality of first layers 11 for an environmental detection. The second environmental sensor 2 emits transmission light in a plurality of second layers 22 for an environmental detection.

FIG. 4A and FIG. 4B show a schematic representation of the front view or of a side view of an overlap region of the fields of view of the environmental sensors in a second sensor arrangement, such as is shown in FIG. 3A. In the second sensor arrangement, the environmental sensors 1, 2 are arranged in such a manner (and for example next to one another as in FIG. 3A, wherein one of the environmental sensors is upside down) that the first layers 11 of the transmission light of the first environmental sensor 1 alternate with the second layers 22 of the transmission light of the second environmental sensor 2 in the overlap region of the fields of view of the environmental sensors 1, 2. In other words, in the overlap region of the fields of view of the environmental sensors 1, 2, as shown in FIG. 4A and FIG. 4B, at least one part of a travel region of an industrial robot (not shown in FIGS. 4A and 4B) can be captured in a resolution (i.e. more image regions with more pixels overall are recorded) that is higher than the resolution of the environmental sensors 1, 2 taken alone in each case. In particular, in the overlap region of the fields of view of the environmental sensors 1, 2, the total number of the (scanning) layers with which the environment is effectively detected can correspond to the number of first layers 11 of the transmission light of the first environmental sensor 1 added to the number of second layers 22 of the transmission light of the second environmental sensor. In this way, a certain PL, for example PL r, can be achieved, even if the environmental sensors 1, 2, taken alone in each case, are possibly not configured as safety sensors and/or cannot achieve the desired PL.

FIG. 5 shows a schematic representation of the front view of a sensor apparatus 100 in a second sensor arrangement. The sensor apparatus 100 shown in FIG. 5 comprises the same or similar components as the sensor apparatus shown in FIG. 3A. The holder 3 in FIG. 5 is configured to hold the environmental sensors 1, 2 in a second sensor arrangement in which the environmental sensors 1, 2 are arranged next to one another, wherein the second environmental sensor 2 is rotated by 180° and is therefore “upside down” compared to the first environmental sensor 1.

The holder 3 of the sensor apparatus 100 in FIG. 5 comprises at least one marking 4, wherein the marking 4 is arranged at the holder 3 such that the marking can be detected by the first environmental sensor 1 and/or by the second environmental sensor 2 for diagnostic purposes. The sensor apparatus 100, as shown, for example, in FIG. 5, can further comprise a processing apparatus (not shown in FIG. 5) that is configured to obtain sensor data about the environment, in particular about at least one part of the travel region of the industrial robot (not shown in FIG. 5), based on reception light received by the first environmental sensor 1 and/or by the second environmental sensor 2, in particular to measure said sensor data using a time-of-flight method.

The processing apparatus (not shown in FIG. 5) can be configured to obtain first sensor data based on the reception light received by the first environmental sensor 1 and to obtain second sensor data based on the reception light received by the second environmental sensor 2, to determine a first position of the marking 4 or a second position of the marking 4 based on the first sensor data and the second sensor data by means of time-of-flight methods and/or an optical distortion of the marking 4 and/or to determine a third position of the marking 4 based on both sensor data by means of lateration and/or triangulation, and to determine an error state of the environmental sensors 1, 2 in that a deviation can be determined on a comparison of the determined first, second and/or third position of the marking 4 with one another and/or on a comparison of the determined first, second and/or third position of the marking 4 with a predetermined position of the marking 4, and/or in that a change in the first, second and/or third position of the marking can be determined over time. The processing apparatus (not shown) can be a separate processing apparatus that is in a wireless or wired signal connection with the environmental sensors 1, 2. The first and/or second position of the marking 4 can optionally be calculated by the separate processing apparatus based on the respective sensor data or can also already be calculated by the respective environmental sensor 1, 2 itself so that only the calculated position is transmitted to the processing apparatus.

FIG. 6, FIG. 7A and FIG. 7B show further possibilities of how the environmental sensors 1, 2 can be arranged in a second sensor arrangement. As shown in FIG. 6 and FIG. 7A, the second environmental sensor 2 can be arranged above and in particular on the first environmental sensor 1. FIG. 7B shows a side view of the front view of a second sensor arrangement shown in FIG. 7A. The second environmental sensor 2 is rotated by 180° and is in particular upside down. Additionally or alternatively, the second environmental sensor 2 can be tilted, as shown in FIG. 6, and can in particular be tilted downwardly.

FIG. 8 shows a schematic representation of the front view of a sensor apparatus 100 in a first sensor arrangement. The sensor apparatus 100 shown in FIG. 8 comprises the same or similar components as the sensor apparatus shown in FIG. 1A. The holder 3 in FIG. 8 is configured to hold the environmental sensors 1, 2 in a first sensor arrangement in which the environmental sensors 1, 2 are arranged next to one another. As can be seen in FIG. 8 and also in FIG. 1A, the environmental sensors 1 and 2 in this respect have the same orientation relative to one another. Furthermore, as shown in FIG. 8, the holder 3 has at least one marking 4, wherein the marking 4 is arranged at the holder 3 such that the marking can be detected by the first environmental sensor 1 and/or by the second environmental sensor 2 for diagnostic purposes. The sensor apparatus 100 in FIG. 8 can further comprise a processing apparatus (not shown in FIG. 8). With regard to the marking 4 and the processing apparatus of the sensor apparatus 100 in FIG. 8, the same applies as described for the sensor apparatus 100 in FIG. 5.

FIG. 9 shows a further possibility of how the environmental sensors 1, 2 can be arranged in a first sensor arrangement. The second environmental sensor 2 can be arranged above and in particular on the first environmental sensor 1, wherein the first and the second environmental sensor 1, 2 have the same orientation relative to one another. Compared to the second sensor arrangements shown in FIG. 6, FIG. 7A and FIG. 7B, the second environmental sensor 2 in this first sensor arrangement is therefore not rotated and/or tilted.

FIG. 10A and FIG. 10B show a schematic representation of the front view or the plan view of a sensor apparatus 100 in a first sensor arrangement. The first environmental sensor 1 and/or the second environmental sensor 2 each comprise a field of view of equal to or more than 180°, preferably equal to or more than 225°, preferably equal to or more than 270°, preferably equal to or more than 315°, and preferably equal to 360°. In this case, the holder 3 can be configured such that the fields of view of the environmental sensors 1, 2 are obstructed as little as possible. In particular, the environmental sensors 1, 2 can each be mounted laterally at one margin of the holder 3, wherein the marking 4 on the holder 3 is located between the environmental sensors 1, 2. In this way, larger side regions of the environment, and in particular also regions behind the holder 3, can be detected (e.g. non-redundantly) with the first layers 11 of the transmission light of the first environmental sensor 1 or the second layers 22 of the transmission light of the second environmental sensor 2, wherein, in the overlap region of the fields of view, the environment is detected (e.g. redundantly) with the first layers 11 of the first environmental sensor 1 and the second layers 22 of the second environmental sensor 2.

FIG. 11 shows a schematic representation of a side view of a system 200 comprising a sensor apparatus 100 in a first sensor arrangement, such as is shown in FIG. 1A, FIG. 8, FIG. 9, FIG. 10A and FIG. 10 B. The system 200 for detecting the travel region of an industrial robot 5 comprises the industrial robot 5 (shown here in FIG. 11 as a tractor) and at least one sensor apparatus 100, wherein the sensor apparatus 100 is mounted at the industrial robot 5. The first layers 11 and the second layers 22 of the transmission light of the environmental sensors 1, 2 of the sensor apparatus 100 arranged in the first sensor arrangement can redundantly detect the travel region of the industrial robot, and can in particular redundantly detect at least one defined test object 300 in the travel region of the industrial robot. For the agricultural sector, the test object can in particular be a test obstacle 300 according to ISO 18497 (cylindrically shaped, maximum radius of 380 mm, minimum radius of 1400 mm, maximum height of 350 mmm plus 270 mm) that can be redundantly detected at a distance of approx. 23000 mm with two first layers 11 and two second layers 22 that are congruent, whereby a certain PL according to ISO 18497 and/or a certain PC according to IEC 62998 can be achieved, for example, PL r according to ISO 13849 and PC r according to IEC 62998 when using environmental sensors with PL r-1 and PC r. It is understood that, depending on the area of application, a different test object can be used that can therefore, for example, have a different shape, be lower or higher and/or have a larger or smaller volume.

The sensor apparatus 100 of the system 200 can comprise a processing apparatus (not shown in FIG. 11), wherein the processing apparatus can be configured to determine a hazardous state based on sensor data of the environmental sensors and, in response to the determination of the hazardous state, to output a signal and/or to set the industrial robot 5 into a safeguarded control mode.

FIG. 12 shows a schematic representation of a plan view of a system 200 for detecting the travel region 7 of an industrial robot 5, here a crane for moving containers. The system 200 comprises the crane 5, wherein the crane can be a rail-guided (gantry) crane and can therefore move on rails 6. The system 200 in FIG. 12 comprises at least two sensor apparatuses 100 as shown, for example, in FIG. 1A, FIG. 3A, and FIG. 5 to FIG. 10B. The crane 5 comprises at least one first crane leg 51 disposed in the direction of travel of the crane and at least one second crane leg 52 disposed opposite to the direction of travel of the crane, wherein at least one sensor apparatus 100 is mounted at the first crane leg 51 and at the second crane leg 52 in each case, and is in particular mounted at a trailer bogie of a respective crane leg 51, 52. The sensor apparatuses 100 can be attached to the crane legs 51, 52, for example, at a height of approximately 5 m.

The crane 5 shown in FIG. 12 comprises two first crane legs 51 and two second crane legs 52. It is understood that the crane 5 can comprise more or fewer crane legs than shown in FIG. 12.

The sensor apparatus 100 at the first crane leg 51 of the crane 5 in FIG. 12 can be oriented in the direction of travel of the crane 5 and the sensor apparatus 100 at the second crane leg 52 can be oriented opposite to the direction of travel of the crane 5. As indicated by the arrow, the crane 5 can also change the direction of travel and can in particular travel alternately in one direction or in the opposite direction. It is understood that the one sensor apparatus 100, which is first oriented in the direction of travel, is then oriented opposite to the direction of travel after a change of direction, and vice versa. At least one sensor apparatus 100 oriented in the direction of travel of the crane and at least one sensor apparatus 100 oriented opposite to the direction of travel of the crane can be mounted at each of the crane legs 51, 52.

The sensor apparatuses 100 can have the same sensor arrangement or a different sensor arrangement. For example, both sensor apparatuses 100 can have the first sensor arrangement or the second sensor arrangement of the environmental sensors. Alternatively, one sensor apparatus 100 can have the first sensor arrangement of the environmental sensors and the other sensor apparatus 100 can have the second sensor arrangement of the environmental sensors.

Furthermore, the sensor apparatuses 100 can be attached to the crane legs such that and can be configured such that the environmental sensors of both sensor apparatuses 100 can also each detect a region 33 between the crane legs 51, 52. This is in particular the case if the first environmental sensors and/or the second environmental sensors of the sensor apparatuses 100 each comprise a field of view of more than 180°, preferably equal to or more than 225°, preferably equal to or more than 270°, preferably equal to or more than 315°, and preferably equal to 360°, as shown, for example, in FIG. 10A and FIG. 10B. It is understood that in this case the holders 3 of the sensor apparatuses 100 can be configured such that the fields of view of the environmental sensors are obstructed as little as possible. The environmental sensors of both sensor apparatuses 100 can each be held (e.g. laterally at the margins of the respective holder and at or projecting from the edges of the respective crane leg 51, 52) such that the environmental sensors can also detect the region 33 between the crane legs 51, 52. In the interaction of the first environmental sensors and the second environmental sensors of both sensor apparatuses 100, the region 33 between the crane legs 51, 52 can be detected redundantly and/or alternately.

In this way, the sensor apparatuses 100 can detect almost the entire or the entire travel region 7 of the crane 5 (redundantly and/or alternately).

1. A sensor apparatus for detecting the travel region of an industrial robot, wherein the sensor apparatus comprises at least one first environmental sensor and one second environmental sensor,
wherein the first environmental sensor emits transmission light in a plurality of first layers for an environmental detection, and
wherein the second environmental sensor emits transmission light in a plurality of second layers for an environmental detection,
wherein the environmental sensors are arranged
such that the first layers of the transmission light of the first environmental sensor coincide with the second layers of the transmission light of the second environmental sensor in an overlap region of the fields of view of the environmental sensors, or
such that the first layers of the transmission light of the first environmental sensor alternate with the second layers of the transmission light of the second environmental sensor in the overlap region of the fields of view of the environmental sensors.

2. The sensor apparatus according to claim 1, wherein the industrial robot is a crane for moving containers.

3. The sensor apparatus according to claim 1, further comprising a holder for the environmental sensors, wherein the holder is configured to hold the environmental sensors at least in a first sensor arrangement or in a second sensor arrangement different from the first sensor arrangement, wherein, in the first sensor arrangement, the first layers of the transmission light of the first environmental sensor coincide with the second layers of the transmission light of the second environmental sensor in the overlap region of the fields of view of the environmental sensors and, in the second sensor arrangement, the first layers of the transmission light of the first environmental sensor alternate with the second layers of the transmission light of the second environmental sensor in the overlap region of the fields of view of the environmental sensors.

4. The sensor apparatus according to claim 3, wherein the holder comprises at least one marking, wherein the marking is arranged at the holder such that the marking can be detected by the first environmental sensor and/or by the second environmental sensor for diagnostic purposes.

5. The sensor apparatus according to claim 1, wherein the sensor apparatus further comprises a processing apparatus that is configured, based on reception light received by the first environmental sensor and/or by the second environmental sensor, to obtain sensor data about the environment.

6. The sensor apparatus according to claim 5, wherein the processing apparatus is configured, based on reception light received by the first environmental sensor and/or by the second environmental sensor, to obtain sensor data about at least one part of the travel region of the industrial robot.

7. The sensor apparatus according to claim 5, wherein the processing apparatus is configured to measure said sensor data using a time-of-flight method.

8. The sensor apparatus according to claim 5, wherein the processing apparatus is configured
to determine a hazardous state based on the sensor data, and,
in response to the determination of the hazardous state, to output a signal and/or to set the industrial robot into a safeguarded control mode.

9. The sensor apparatus according to claim 4,, wherein the sensor apparatus further comprises a processing apparatus that is configured, based on reception light received by the first environmental sensor and/or by the second environmental sensor, to obtain sensor data about the environment, wherein the processing apparatus is configured
to obtain first sensor data based on the reception light received by the first environmental sensor and to obtain second sensor data based on the reception light received by the second environmental sensor,
to determine a first position of the marking or a second position of the marking based on the first sensor data and the second sensor data by means of time-of-flight methods and/or an optical distortion of the marking and/or to determine a third position of the marking based on both sensor data by means of lateration and/or triangulation, and to determine an error state of the environmental sensors
in that a deviation can be determined on a comparison of the determined first, second and/or third position of the marking with one another and/or on a comparison of the determined first, second and/or third position of the marking with a predetermined position of the marking, and/or
in that a change in the first, second and/or third position of the marking can be determined over time.

10. The sensor apparatus according to claim 9, wherein the processing apparatus is configured
to determine a hazardous state based on the sensor data, and,
in response to the determination of the hazardous state, to output a signal and/or to set the industrial robot into a safeguarded control mode.

11. The sensor apparatus according to claim 3, wherein the holder is configured to variably hold the environmental sensors at least between the first sensor arrangement and the second sensor arrangement.

12. The sensor apparatus according to claim 1, wherein the environmental sensors are arranged next to one another or above one another.

13. The sensor apparatus according to claim 1, wherein one of the environmental sensors is arranged tilted and/or rotated, with respect to the other so that the first layers of the transmission light of the first environmental sensor alternate with the second layers of the transmission light of the second environmental sensor in the overlap region of the fields of view of the environmental sensors.

14. The sensor apparatus according to claim 13, wherein one of the environmental sensors is arranged tilted and/or rotated by 180°, with respect to the other.

15. The sensor apparatus according to claim 1, wherein the first and/or the second environmental sensor is/are configured as a safety sensor.

16. The sensor apparatus according to claim 1, wherein the first and/or the second environmental sensor comprises/comprise a respective field of view of equal to or more than 180°.

17. Method of detecting a travel region of an industrial robot using a sensor
apparatus for detecting the travel region of an industrial robot,
wherein the sensor apparatus comprises at least one first environmental sensor and one second environmental sensor,
wherein the first environmental sensor emits transmission light in a plurality of first layers for an environmental detection, and
wherein the second environmental sensor emits transmission light in a plurality of second layers for an environmental detection,
wherein the environmental sensors are arranged
such that the first layers of the transmission light of the first environmental sensor coincide with the second layers of the transmission light of the second environmental sensor in an overlap region of the fields of view of the environmental sensors, or
such that the first layers of the transmission light of the first environmental sensor alternate with the second layers of the transmission light of the second environmental sensor in the overlap region of the fields of view of the environmental sensors.

18. Method of claim 17, wherein the industrial robot is a crane for moving containers.

19. A system for detecting the travel region of an industrial robot, said system comprising
the industrial robot, and
at least one sensor apparatus according to claim 1, wherein the sensor apparatus is mounted at the industrial robot.

20. The system according to claim 19,
wherein the industrial robot is a crane; and
wherein the crane comprises at least one first crane leg disposed in the direction of travel of the crane and at least one second crane leg disposed opposite to the direction of travel of the crane,
wherein at least one sensor apparatus is mounted at the first and at the second crane leg in each case.

21. The system according to claim 20, wherein at least one sensor apparatus is mounted at a trailer bogie of a respective crane leg.

22. The system according to claim 20, wherein the sensor apparatus at the first crane leg is oriented in the direction of travel of the crane and the sensor apparatus at the second crane leg is oriented opposite to the direction of travel of the crane.

23. The system according to claim 22, wherein the sensor apparatuses are configured such that the environmental sensors of the sensor apparatuses can also detect a region between the crane legs.

24. The system according to claim 23, wherein the environmental sensors of both sensor apparatuses are configured and held such that the environmental sensors of the sensor apparatuses can also detect a region between the crane legs.
